(19) United States
(12) Patent Application Publication
(10) Pub. No.: US 2013/0341972 A1
(43) Pub. Date: Dec. 26, 2013

(54) ROLLER BLIND APPARATUS FOR PANORAMIC SUNROOFS

(71) Applicant: WEBASTO DONGHEE CO., LTD., Ulsan (KR)

(72) Inventors: Su-Yun Choi, Ulsan (KR); Jong-Rak Kim, Ulsan (KR); Seong-Min Gwak, Ulsan (KR); Chang-Min Park, Busan (KR)

(73) Assignee: WEBASTO DONGHEE CO., LTD., Ulsan (KR)

(21) Appl. No.: 13/894,939

(22) Filed: May 15, 2013

(30) Foreign Application Priority Data
Jun. 21, 2012 (KR) 10-2012-0066655

(51) Int. Cl. B60J 7/00

(52) U.S. Cl. CPC B60J 7/0015
USPC 296/214

(57) ABSTRACT

A roller blind apparatus for panoramic sunroofs, in which front and rear roller blinds can be opened or closed by respective motors, thereby providing more convenience to a user. The apparatus includes front and rear roller blinds; a first drive means generating drive power for opening or closing the front roller blind; a second drive means generating drive power for opening or closing the rear roller blind such that the rear roller blind can be operated separately from the front roller blind; a power transmission unit that transmits the drive power of the first drive means so as to allow a moving glass to be operated in conjunction with the opening/closing motion of the front roller blind; and a control unit that controls a supply of electric power to the first and second drive means so as to control the motions of the front and rear roller blinds.

### CROSS-REFERENCE TO RELATED APPLICATIONS

This application claims priority to Korean Patent Application No. 10-2012-0066655 filed on 21 Jun. 2012, which is incorporated herein by reference.

### TECHNICAL FIELD

The present invention relates, in general, to a roller blind apparatus for panoramic sunroofs and, more particularly, to a roller blind apparatus, in which a front roller blind and a rear roller blind are connected to respective drive motors such that the opening/closing operation of the front roller blind and the opening/closing operation of the rear roller blind can be performed separately and such that a sunroof glass can be opened or closed in conjunction with the opening/closing operation of the front roller blind, thereby providing more convenience to a user.

### RELATED ART

For many years, to allow passengers of vehicles to feel open and free, opening sunroofs that can be selectively opened and closed have been installed in the roofs of vehicles. Among more recent opening sunroofs, a panoramic sunroof in which a sunroof panel is completely formed by a glass structure has particularly impressed customers, and a trend has emerged where an increasing number of customers desire to own vehicles provided with such a sunroof.

The panoramic sunroof is formed by a glass structure and so the sunlight may shine directly into the interior of a vehicle through the glass sunroof. Accordingly, to appropriately brighten the interior of the vehicle while preventing sunlight from entering into the interior of the vehicle, a folding roller blind that is selectively opened or closed is typically installed together with the panoramic sunroof.

In the related art, to allow easy full opening and easy partial opening of the sunroof, the roller blind typically comprises a front roller blind and a rear roller blind. Further, the related art panoramic sunroof includes a moving glass in the front and a fixed glass in the rear.

Here, the moving glass and the roller blind of the related art panoramic sunroof are configured to be operated using respective drive motors. That is, in addition to a drive motor for operating the moving glass, another drive motor for operating both the front roller blind and the rear roller blind is installed in the panoramic sunroof.

However, the above-mentioned related art technique is problematic in that the front roller blind and the rear roller blind are configured to be opened or closed at the same time so that, even when it is not required to open the rear roller blind, the rear roller blind is undesirably opened when an opening operation of the front roller blind is performed.

Accordingly, it is required to propose a technique that can drive the front roller blind and the rear roller blind separately from each other so that the front roller blind and the moving glass can be opened without being accompanied by an opening motion of the rear roller blind.

In the related art, a drive motor for operating the roller blind and another drive motor for operating the moving glass are provided, thereby complicating the construction of the sunroof. In an effort to solve the problems, Korean Patent Laid-open Publication No. 10-2012-0014615 (Patent Document 1) discloses an interlock type roll blind apparatus of a panoramic sunroof, which is configured such that a blind can be opened in conjunction with an opening motion of a sunroof glass, and such that the blind is not closed when the sunroof glass is in an open state.

The technique of the roll blind apparatus disclosed in the Patent Document 1 is a technique that can be used in a manually-operated blind apparatus and in which the blind can be opened in conjunction with an opening motion of the sunroof glass. However, to close the blind in the related art roll blind apparatus, a user should manually pull a handle upper after closing the sunroof glass so as to remove an interference of a slider, and when the user pulls the handle upper, the blind closes by an unfolding motion of the blind. Accordingly, the technique of the related art roll blind apparatus is problematic in that it causes inconvenience to a user and cannot be applied to a motored roller blind.

### SUMMARY

Accordingly, the present invention has been made keeping in mind the above problems occurring in the related art, and the present invention is intended to propose a roller blind apparatus, in which one drive motor is provided to open or close both a front roller blind and a moving glass in such a way that the front roller blind and the moving glass can be opened or closed in conjunction with each other, and another drive motor is connected to a rear roller blind such that the opening/closing operation of the rear roller blind can be performed separately from an operation of the front roller blind, and which can allow the rear roller blind to be operated separately from the front roller blind even though the apparatus uses two drive motors.

In order to achieve the above objects, according to one aspect of the present invention, there is provided a roller blind apparatus for panoramic sunroofs, including a front roller blind and a rear roller blind provided in front and rear sections of a sunroof that is installed in a vehicle roof panel, so that the front and rear roller blinds can be manually opened or closed by a user, further including: a first drive means that generates drive power for realizing an opening/closing motion of the front roller blind; a second drive means that generates drive power for realizing an opening/closing motion of the rear roller blind in such a way that the rear roller blind can be operated separately from the front roller blind; a power transmission unit that transmits the power of the first drive means so as to allow a moving glass to be operated in conjunction with the opening/closing motion of the front roller blind; and a control unit that controls a supply of electric power to the first and second drive means so as to control the motions of the front roller blind and the rear roller blind.

The power transmission unit may be configured such that the moving glass can be opened after the opening motion of the front roller blind has been completed, and such that the closing motion of the front roller blind can be performed in conjunction with a closing motion of the moving glass.

In the present invention, the power transmission unit may include: a front blind overmold connected to a first cable actuated by the first drive means so that the front blind overmold can slide inside a guide rail by the drive power of the first drive means; a winding guide mounted to the guide rail at a predetermined location at which the front roller blind is opened; a guide lever configured such that, when the front blind overmold slides and reaches a position of the winding guide in a state in which the guide lever is inserted into the winding guide, the guide lever is rotated around a hinge provided in a first end thereof and is engaged with the front blind overmold, thereby sliding inside the guide rail; and a mechanism overmold mounted to a glass mechanism of the moving glass, with the guide lever being hinged to an end of the mechanism overmold, so that, when the guide lever slides in a state in which the guide lever is engaged with the front blind overmold, the mechanism overmold moves the moving glass, wherein the drive power of the first drive means may be transmitted such that, when the guide lever slides along the guide rail in a state in which the guide lever is engaged with the front blind overmold, the moving glass can be moved.

The front blind overmold may be provided with an insert part that protrudes so as to be inserted into a lower surface of the guide lever; the guide lever may be provided in the lower surface thereof with a holding part into which the insert part can be inserted, with a hook part being provided in a second end of the guide lever so that the hook part can be inserted into the winding guide; and the winding guide may be provided in a lower surface thereof with a hooking groove into which the hook part can be inserted.

Here, the hook part may include: an upper surface inclined downward in a direction toward the hinged end of the guide lever; and a lower surface inclined downward in a state in which the lower surface forms an acute angle with the upper surface of the hook part.

The roller blind apparatus may further include: a control hook moving along with the front blind overmold to a stop position of the front roller blind, thereby aiding an opening motion of the front roller blind.

The roller blind apparatus may further include: a stopper mounted to the mechanism overmold and configured such that, when the guide lever is inserted into the winding guide, the stopper is rotated by a tensile force and supports a lower part of the guide lever, thereby preventing a downward movement of the guide lever.

The power transmission unit may be provided on each of guide rails that are placed in opposite sides of the vehicle roof panel.

As described above, in the present invention, the front roller blind and the rear roller blind are connected to respective drive motors such that the opening/closing operations of the front roller blind and the rear roller blind can be performed separately from each other, and both the front roller blind and the moving glass can be opened or closed in conjunction with each other. Accordingly, the present invention can allow the rear roller blind to be operated separately from the front roller blind even though the present invention uses two drive motors.

### BRIEF DESCRIPTION OF THE DRAWINGS

The above and other objects, features and other advantages of the present invention will be more clearly understood from the following detailed description when taken in conjunction with the accompanying drawings, in which:

FIG. 1 is a perspective view illustrating the construction of a roller blind apparatus for panoramic sunroofs according to the present invention;

FIG. 2 is a perspective view illustrating a power transmission unit of the roller blind apparatus of the present invention;

FIG. 3 is an enlarged perspective view illustrating an important part of the power transmission unit of the present invention;

FIG. 4A is an enlarged sectional view illustrating the important part of the power transmission unit of the present invention, in which a front blind overmold is in a state before it is inserted into a guide lever;

FIG. 4B is an enlarged sectional view illustrating the important part of the power transmission unit of the present invention, in which the front blind overmold is inserted into the guide lever;

FIG. 5 is an enlarged perspective view illustrating an important part of the roller blind apparatus of the present invention when a roller blind is being initially opened;

FIG. 6 is a perspective view illustrating a state in which the front roller blind of the roller blind apparatus according to the present invention is being opened;

FIG. 7 is a perspective view illustrating a state in which power is being transmitted in the roller blind apparatus of the present invention;

FIGS. 8A and 8B are sectional views illustrating a state in which power is being transmitted in the roller blind apparatus of the present invention;

FIG. 9 is a perspective view illustrating a state in which a sunroof glass is being opened in the roller blind apparatus of the present invention;

FIGS. 10A and 10B are sectional views illustrating a state in which the sunroof glass is being closed in the roller blind apparatus of the present invention;

FIGS. 11A and 11B are bottom plane views illustrating the state in which the sunroof glass is being closed in the roller blind apparatus of the present invention; and

FIG. 12 is a perspective view illustrating the state in which the sunroof glass is being closed in the roller blind apparatus of the present invention.

### DETAILED DESCRIPTION

Hereinbelow, preferred embodiments of a two-way interlock sliding system and a roller blind apparatus having the system according to the present invention will be described in detail with reference to the accompanying drawings. However, it should be understood that the present invention is not limited to the preferred embodiments described hereinbelow, but may be embodied in the form of various configurations and that the preferred embodiments are intended merely to aid in the understanding of the present invention and to appropriately inform those skilled in the art of the scope of the present invention.

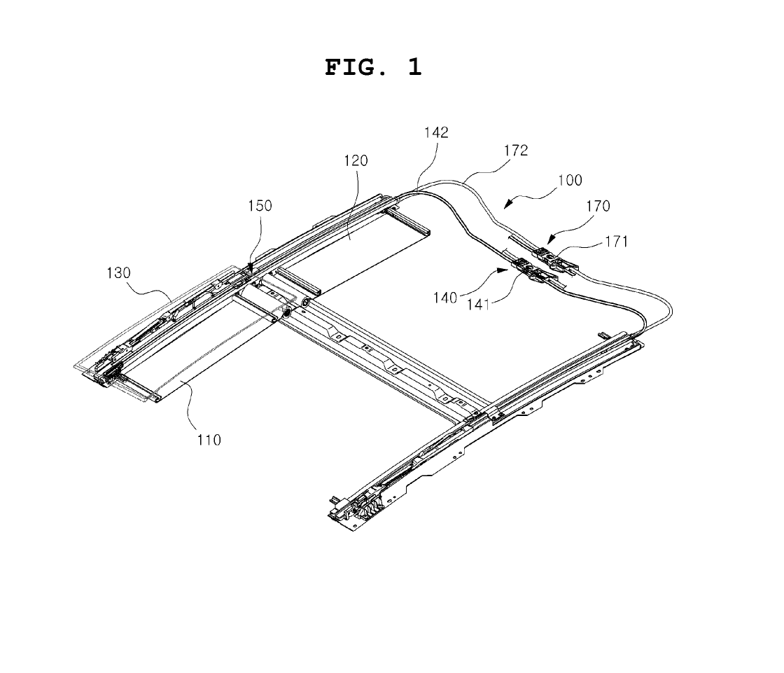

FIG. 1 is a perspective view illustrating the construction of a roller blind apparatus for panoramic sunroofs according to the present invention.

As shown in FIG. 1, the roller blind apparatus 100 for panoramic sunroofs according to the present invention includes a front roller blind 110, a rear roller blind 120, a first drive means 140 that generates drive power for realizing an opening/closing motion of the front roller blind 110, a second drive means 170 that generates drive power for realizing an opening/closing motion of the rear roller blind 120, a moving glass 130 of a sunroof, a power transmission unit 150 that transmits the power so as to allow the moving glass 130 to be operated in conjunction with the opening/closing motion of the front roller blind 110, and a control unit (not shown) that controls a supply of electric power to the first and second drive means so as to control the motions of the front roller blind 110 and the rear roller blind 120.

The front roller blind 110 is provided in the front section of the sunroof that is installed in a vehicle roof panel, so that the front roller blind 110 can be manually opened or closed by a user. The roller blind apparatus 100 of the present invention is configured such that the front roller blind 110 can be opened or closed by the first drive means 140 and the rear roller blind 120 can be opened or closed by the second drive means 170 so that, when it is not required to open the rear roller blind 120, it is possible to open only the front roller blind 110.

The first drive means 140 includes a first drive motor 141 that can generate the drive power for opening or closing the front roller blind 110, and a first cable 142 that is connected at a first end thereof to the first drive motor 141 and is connected at a second end thereof to the front roller blind 110.

Further, the second drive means 170 includes a second drive motor 171 that generates the drive power for opening closing the rear roller blind 120, and a second cable 172 that is connected at a first end thereof to the second drive motor 171 and is connected at a second end thereof to the rear roller blind 120.

Here, each of the first and second drive motors 141 and 171 can be rotated in opposite directions in response to a user's manipulation of a switch (not shown) so that the first and second drive motors 141 and 171 can open or close the front roller blind 110 and the rear roller blind 120, respectively.

The construction in which the front roller blind 110 and the rear roller blind 120 are connected respectively to the first cable 142 and the second cable 172 will be described later herein.

Further, the roller blind apparatus 100 of the present invention is characterized in that the drive power of the first drive means 140 can be transmitted in such a way that the moving glass 130 can be operated in conjunction with the opening/closing operation of the front roller blind 110.

To this end, the power transmission unit 150 is provided so as to transmit the drive power such that the moving glass 130 can be operated in conjunction with the opening/closing operation of the front roller blind 110.

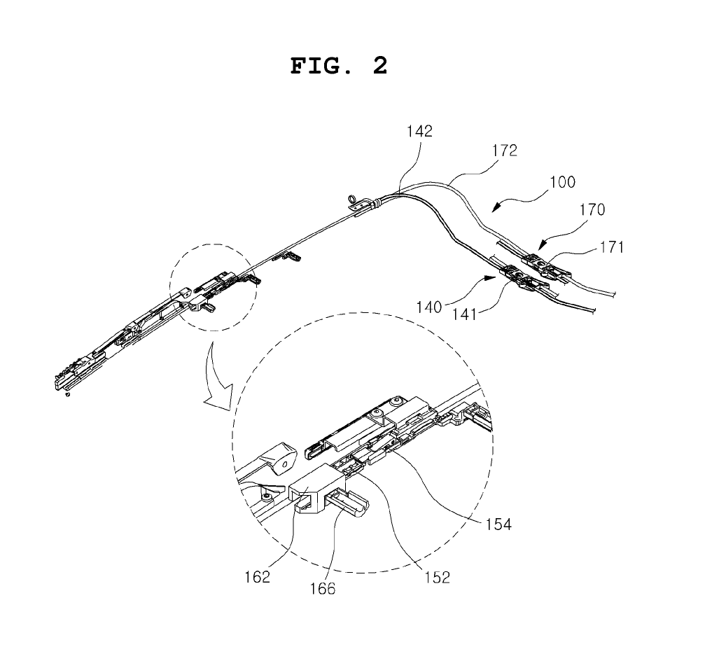

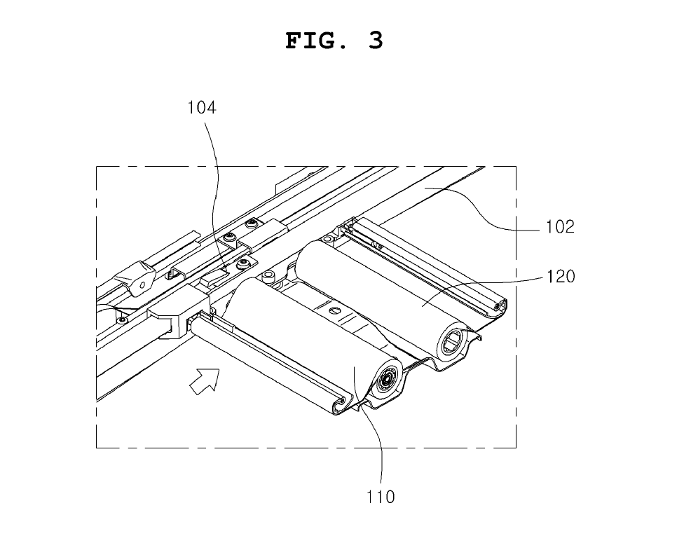

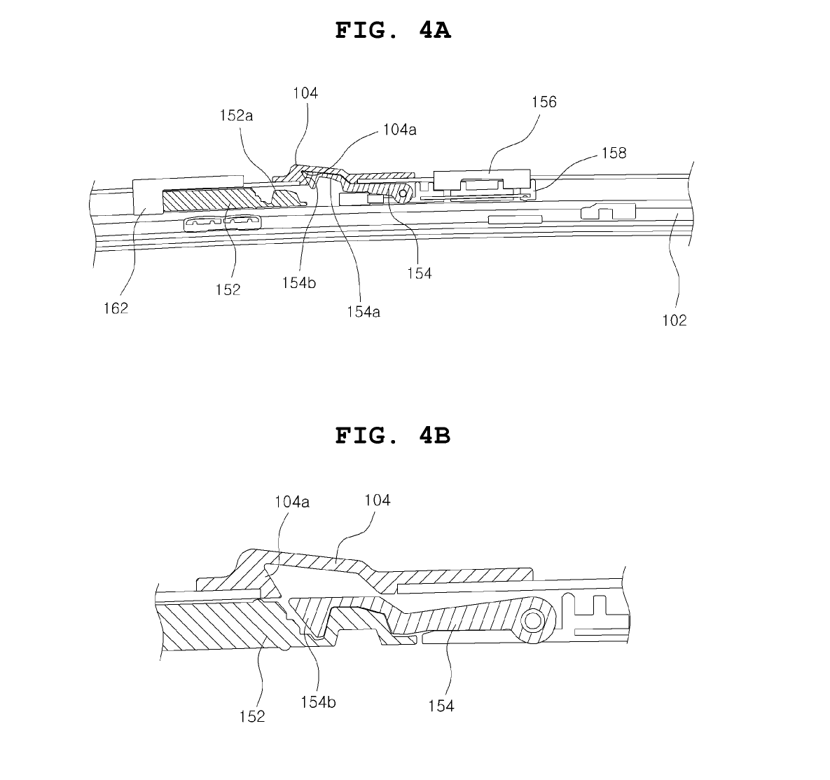

FIG. 2 is a perspective view illustrating the power transmission unit of the roller blind apparatus of the present invention. FIG. 3 is an enlarged perspective view illustrating an important part of the power transmission unit of the present invention. FIG. 4A is an enlarged sectional view illustrating the important part of the power transmission unit of the present invention, in which a front blind overmold is in a state before it is inserted into a guide lever.

In the present invention, the power transmission unit 150 is operated such that the moving glass 130 can be opened after the front roller blind 110 is opened, and such that the front roller blind 110 can be closed in conjunction with a closing motion of the moving glass 130.

Further, in the drawings, the power transmission unit 150 is shown as being provided on one side of the vehicle roof panel. However, it should be understood that the power transmission unit 150 may be provided on each of guide rails that are installed in opposite sides of the vehicle roof panel.

Described in detail, the power transmission unit 150 includes a front blind overmold 152 that is connected to the first cable 142 and slides inside a guide rail 102 by the power of the first drive motor 141, a winding guide 104 that is mounted to the guide rail 102, a guide lever 154 that is configured such that when the front blind overmold 152 reaches the winding guide 104 in a state in which the guide lever 154 is inserted into the winding guide 104, the guide lever 154 is engaged with the front blind overmold 152, and a mechanism overmold 158 that is mounted to a glass mechanism 156 of the moving glass 130 and to one end of which the guide lever 154 is hinged, so that the mechanism overmold 158 can move the moving glass 130 in response to a sliding motion of the guide lever 154.

The front blind overmold 152 is connected to the first cable 142 and pulls or pushes the front roller blind 110. Here, a control hook 162 is installed on the front blind overmold 152 so that the control hook 162 can move along with the front blind overmold 152 to a stop position of the front roller blind 110, thereby aiding the opening motion of the front roller blind 110.

The control hook 162 is combined with a front shoe 166 to which an end of the front roller blind 110 is mounted. The control hook 162 is operated together with the front blind overmold 152 when the front roller blind 110 is opened.

Further, a rear blind overmold that is connected to the second cable 172 is installed in the rear roller blind 120, so that the rear blind overmold can slide along the guide rail 102 by the power of the second drive motor 171 and can open or close the rear roller blind 120.

The winding guide 104 is mounted to the guide rail 102. Here, as shown in FIG. 3, the winding guide 104 is mounted to the guide rail 102 at a location at which the front roller blind 110 is fully opened.

Further, the winding guide 104 is provided in a lower surface thereof with a hooking groove 104a into which the guide lever 154 can be inserted. The hooking groove 104a has a shape into which the guide lever 154 can be efficiently inserted. A hook part 154b that can be inserted into the hooking groove 104a of the winding guide 104 is formed in a second end of the guide lever 154.

Here, it is preferred that both the hook part 154b and the hooking groove 104a be configured to have shapes corresponding to each other.

Here, one end of the guide lever 154, that is, an end facing a direction in which the moving glass 130 is opened, is hinged to the mechanism overmold 158. As shown in FIGS. 4A and 4B, the hook part 154b of the guide lever 154 includes an upper surface that is inclined downward in a direction toward the hinged end of the guide lever 154 or in a direction in which the moving glass 130 is opened, and a lower surface that is inclined downward in a state in which the lower surface forms an acute angle with the upper surface of the hook part 154b.

As described above, the angle that is defined between the upper and lower surfaces of the hook part 154b forms an acute angle of less than 90°, and the lower surface of the hook part 154b forms an inclined surface that is inclined downward in a direction toward the hinged end of the guide lever 154, as shown in the drawings, so that the front roller blind 110 can slide in an opening direction and the guide lever 154 can be removed from the winding guide 104. However, in an opposite direction, when the guide lever 154 is inserted into the winding guide 104, the inserted state of the guide lever 154 in the winding guide 104 can be firmly held by the hook part 154b. Further, the inserted state of the guide lever 154 in the winding guide 104 can be supported by a stopper that rotates by a tensile force and supports the lower part of the guide lever 154 when the guide lever 154 is inserted into the winding guide 104. The above-mentioned stopper will be described in detail later herein.

Further, the front blind overmold 152 is provided with an insert part 152a that protrudes so as to be inserted into the lower surface of the guide lever 154. The lower surface of the guide lever 154 is provided with a holding part 154a into which the insert part 152a is inserted.

The above-mentioned power transmission unit 150 of the present invention is configured such that, when the front blind overmold 152 slides and reaches a location of the winding guide 104 in a state in which the guide lever 154 is inserted into the winding guide 104, the front blind overmold 152 comes into contact with the mechanism overmold 158 and both the front blind overmold 152 and the mechanism overmold 158 slide in a direction in which the front roller blind 110 is opened.

In the above state, in response to a sliding motion of the mechanism overmold 158, the guide lever 154 in the drawings slides and is rotated counterclockwise in a state in which the guide lever 154 is inserted into the hooking groove 104a of the winding guide 104, so that the guide lever 154 is removed from the winding guide 104 and, at the same time, the guide lever 154 is engaged with the front blind overmold 152.

Further, the front shoe 166 is separated from the front blind overmold 152 in the above state, thereby allowing the front blind overmold 152 to move.

Accordingly, when the front blind overmold 152 further slides, the guide lever 154 that is engaged with the front blind overmold 152 slides and the mechanism overmold 158 to which the guide lever 154 is hinged slides along with the front blind overmold 152.

Here, the mechanism overmold 158 is mounted to the glass mechanism 156 of the moving glass 130 so that the moving glass 130 can be moved in response to the sliding motion of the mechanism overmold 158, thereby being opened.

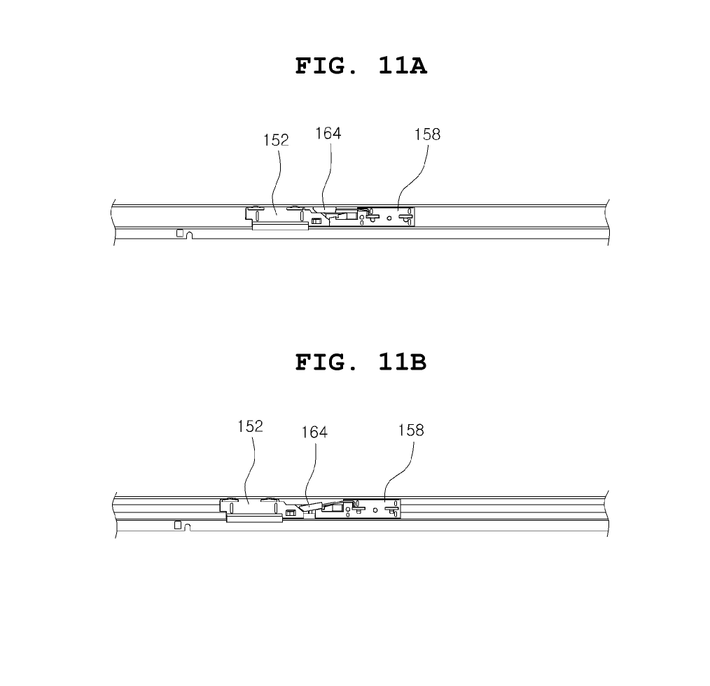

On the other hand, as shown in FIGS. 11A and 11B, the roller blind apparatus 100 of the present invention is provided with a stopper 164 that is mounted to the mechanism overmold 158. In a state in which the guide lever 154 is removed from the winding guide 104, the stopper 164 moves to an edge as shown in FIG. 11A and transmits power to the mechanism overmold 158.

Further, when the guide lever 154 is inserted into the winding guide 104, the stopper 164 is rotated by a tensile force as shown in FIG. 11B and supports the lower part of the guide lever 154, thereby preventing an unexpected downward movement of the guide lever 154. Accordingly, the stopper 164 can maintain the inserted state of the guide lever 154 in the winding guide 104.

The operation of the roller blind apparatus for panoramic sunroofs of the present invention having the above-mentioned construction will described hereinbelow.

A driver of a vehicle can open the sunroof so as to ventilate the interior of the vehicle. In the above state, the driver can open or close at least one of the front roller blind and the rear roller blind.

When the driver manipulates the switch so as to open the front roller blind 110, the roller blind apparatus for panoramic sunroofs of the present invention will be operated as follows.

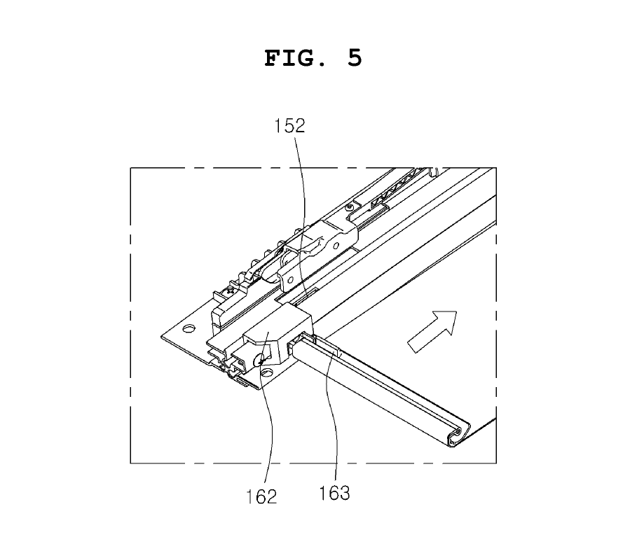

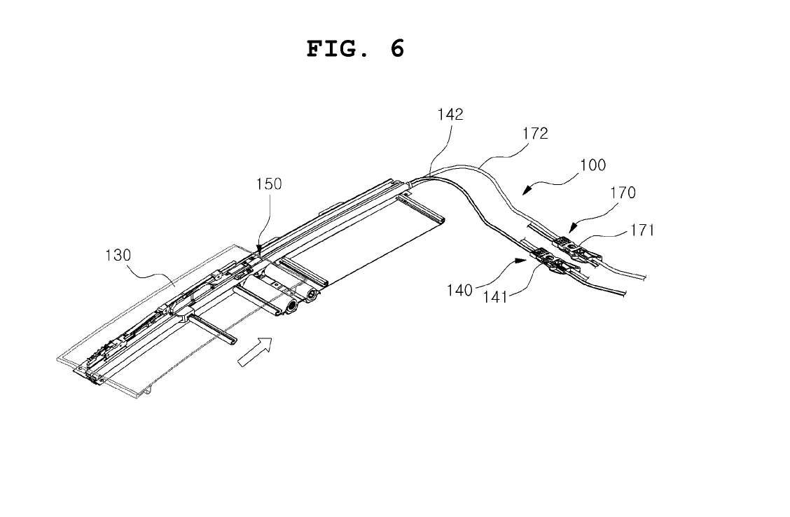

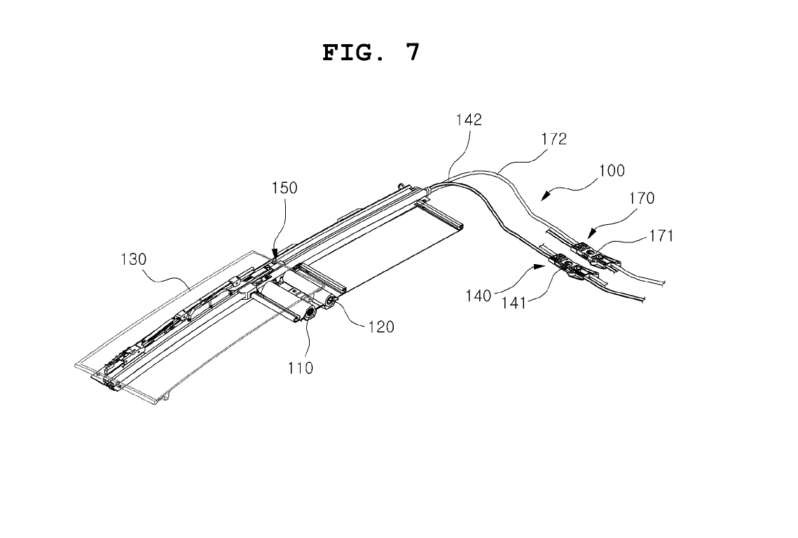

FIG. 5 is an enlarged perspective view illustrating an important part of the roller blind apparatus of the present invention when a roller blind is being initially opened. FIG. 6 is a perspective view illustrating a state in which the front roller blind of the roller blind apparatus according to the present invention is being opened. FIG. 7 is a perspective view illustrating a state in which the drive power is being transmitted in the roller blind apparatus of the present invention;

First, the front blind overmold 152 that is connected to the first cable 142 is moved by the drive power of the first drive motor 141.

In the above state, the control hook 162 that is mounted to the outer surface of the guide rail 102 slides along with the front blind overmold 152 to a stop position of the front roller blind 110 and aids an opening motion of the front roller blind 110.

Thereafter, when the front roller blind 110 is completely opened, the power transmission unit 150 of the present invention transmits the power of the first drive motor 141 to the moving glass 130.

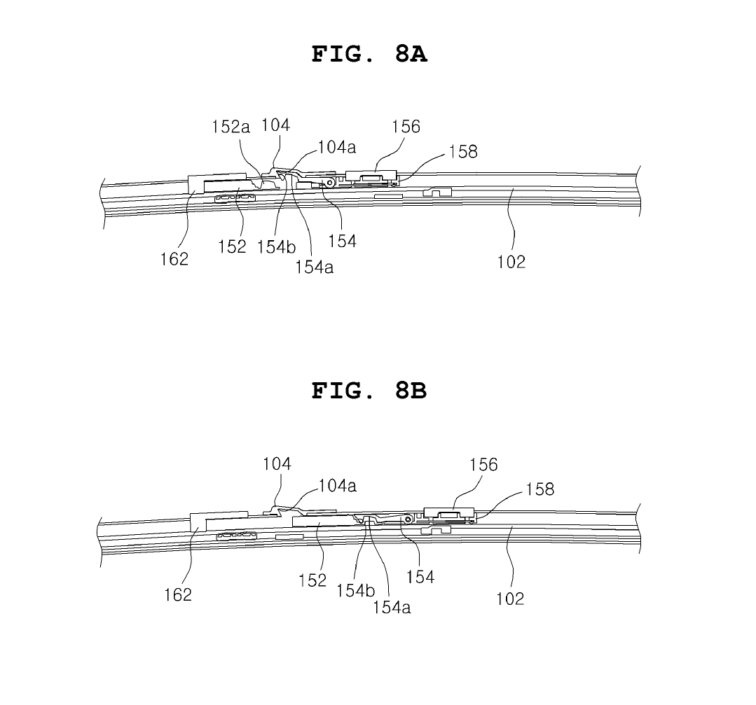

That is, as shown in FIGS. 8A and 8B, when the front roller blind 110 is completely opened, the front blind overmold 152 slides and reaches a location of the winding guide 104 and, in the above state, the front blind overmold 152 comes into contact with the mechanism overmold 158, so that both the front blind overmold 152 and the mechanism overmold 158 can slide at the same time.

Here, in response to the sliding motion of the mechanism overmold 158, the guide lever 154 that is hinged to the mechanism overmold 158 slides and is rotated so that the guide lever 154 is removed from the winding guide 104 and, at the same time, the guide lever 154 is engaged with the front blind overmold 152 and slides along the guide rail 102.

Therefore, when the front blind overmold 152 further slides, the guide lever 154 that is engaged with the front blind overmold 152 also slides. In the above state, the mechanism overmold 158 that is combined with the guide lever 154 is fixed to the glass mechanism 156 of the moving glass 130, so that the moving glass 130 can be moved.

Here, when the guide lever 154 is removed from the winding guide 104, the stopper 164 moves to an edge and transmits the power to the mechanism overmold 158.

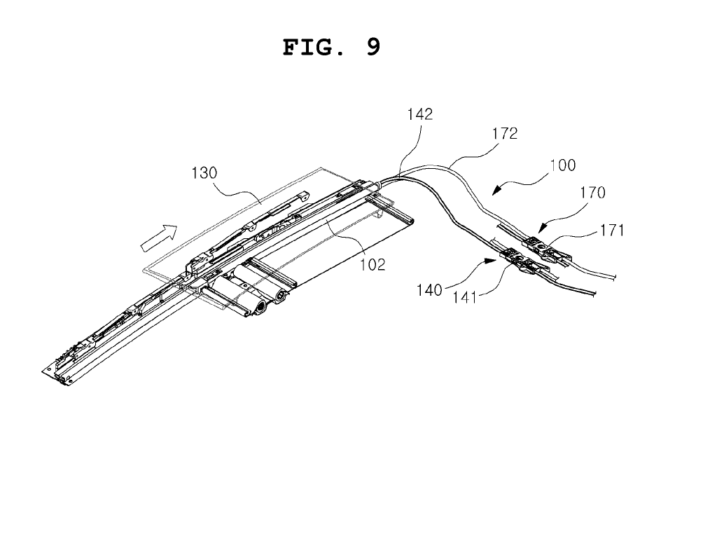

Accordingly, the moving glass 130 is connected to the first drive motor 141 and can be opened, as shown in FIG. 9.

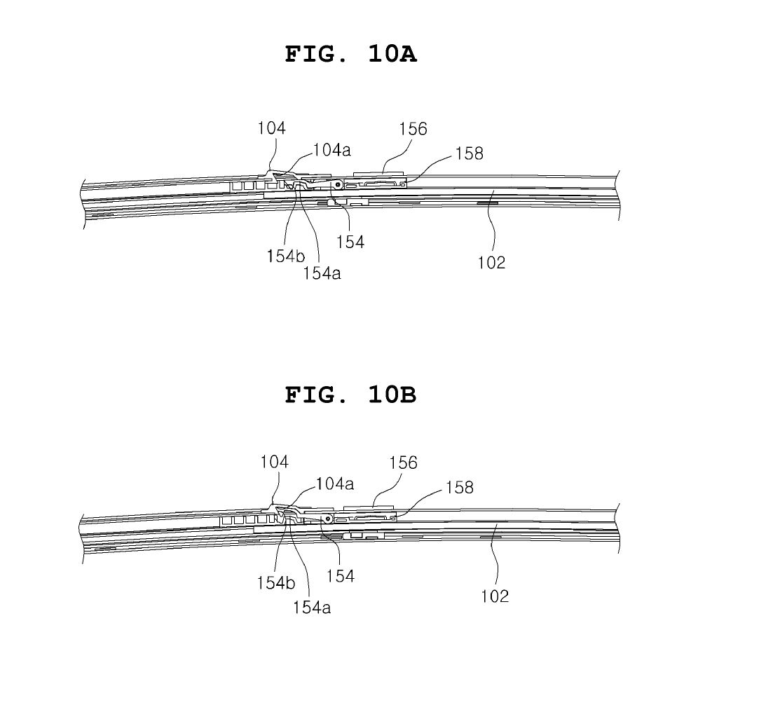

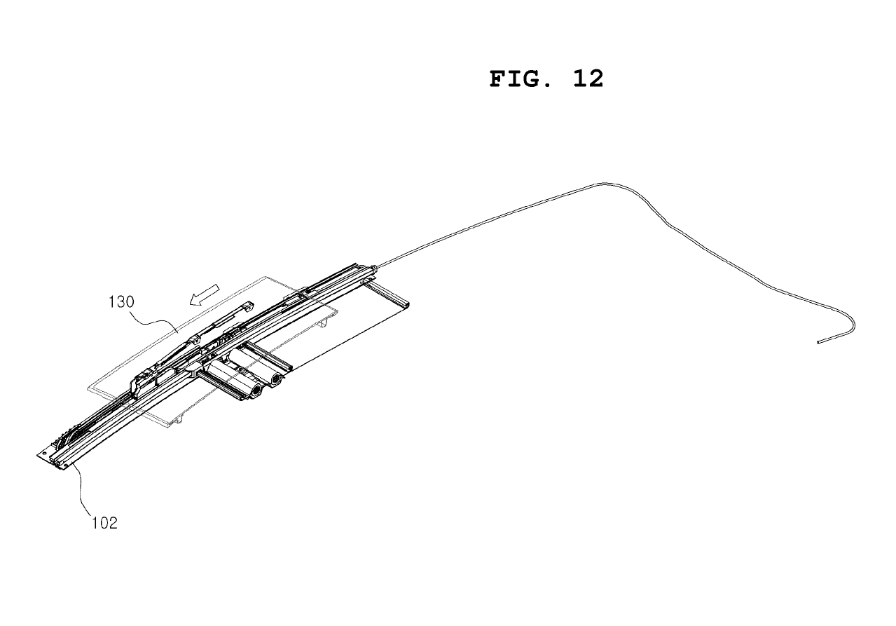

FIGS. 10A and 10B are sectional views illustrating a state in which the sunroof glass is being closed in the roller blind apparatus of the present invention. FIGS. 11A and 11B are bottom plane views illustrating the state in which the sunroof glass is being closed in the roller blind apparatus of the present invention. FIG. 12 is a perspective view illustrating the state in which the sunroof glass is being closed in the roller blind apparatus of the present invention.

The operation for closing the moving glass 130 is performed by transmitting the power of the first drive motor 141 to the moving glass 130 by an engagement of the front blind overmold 152 with the guide lever 154, thereby closing the moving glass 130.

When the front blind overmold 152 slides by the first cable 142 in a direction in which the moving glass 130 is closed, and reaches the location of the winding guide 104, the guide lever 154 is rotated and inserted into the hooking groove 104a of the winding guide 104.

Here, because the hook part 154b of the guide lever 154 is configured such that the hook part 154b forms an acute angle in a direction in which the front roller blind 110 is closed, the guide lever 154 that is engaged with the hooking groove 104a cannot further slide in the closing direction of the front roller blind 110 and the front roller blind 110 moves after being removed from the guide lever 154.

Further, the stopper 164 is rotated by a tensile force and prevents an unexpected downward movement of the guide lever 154, thereby maintaining the inserted state of the guide lever 154 in the hooking groove 104a of the winding guide 104.

Accordingly, the front roller blind 110 can be closed in conjunction with a closing motion of the moving glass 130.

On the other hand, to open or close the rear roller blind 120, the user manipulates the switch so as to operate the second drive motor 171 so that the rear blind overmold slides along the guide rail 102 by the second cable 172 that is connected to the second drive motor 171, thereby opening or closing the rear roller blind 120.

As described above, in the present invention, the front roller blind and the rear roller blind which are installed in a vehicle sunroof are connected to respective drive motors so that the front roller blind and the rear roller blind can be separately opened or closed and the moving glass can be operated in conjunction with the opening/closing operation of the front roller blind. Therefore, the present invention is advantageous in that it can provide more convenience to a user by using two drive motors.

Although a preferred embodiment of the present invention has been described for illustrative purposes, those skilled in the art will appreciate that various modifications, additions and substitutions are possible, without departing from the scope and spirit of the invention as disclosed in the accompanying claims.

What is claimed is:

1. A roller blind apparatus for panoramic sunroofs, comprising a front roller blind and a rear roller blind provided in front and rear sections of a sunroof that is installed in a vehicle roof panel, so that the front and rear roller blinds can be manually opened or closed by a user, further comprising:
a first drive means that generates drive power for realizing an opening/closing motion of the front roller blind;
a second drive means that generates drive power for realizing an opening/closing motion of the rear roller blind in such a way that the rear roller blind can be operated separately from the front roller blind;
a power transmission unit that transmits the power of the first drive means so as to allow a moving glass to be operated in conjunction with the opening/closing motion of the front roller blind; and
a control unit that controls a supply of electric power to the first and second drive means so as to control the motions of the front roller blind and the rear roller blind.

2. The roller blind apparatus for panoramic sunroofs as set forth in claim 1, wherein the power transmission unit is configured such that the moving glass can be opened after the opening motion of the front roller blind has been completed, and such that the closing motion of the front roller blind can be performed in conjunction with a closing motion of the moving glass.

3. The roller blind apparatus for panoramic sunroofs as set forth in claim 1 or 2, wherein the power transmission unit comprises:
a front blind overmold connected to a first cable actuated by the first drive means so that the front blind overmold can slide inside a guide rail by the drive power of the first drive means;
a winding guide mounted to the guide rail at a predetermined location at which the front roller blind is opened;
a guide lever configured such that, when the front blind overmold slides and reaches a position of the winding guide in a state in which the guide lever is inserted into the winding guide, the guide lever is rotated around a hinge provided in a first end thereof and is engaged with the front blind overmold, thereby sliding inside the guide rail; and
a mechanism overmold mounted to a glass mechanism of the moving glass, with the guide lever being hinged to an end of the mechanism overmold, so that, when the guide lever slides in a state in which the guide lever is engaged with the front blind overmold, the mechanism overmold moves the moving glass,
wherein the drive power of the first drive means is transmitted such that, when the guide lever slides along the guide rail in a state in which the guide lever is engaged with the front blind overmold, the moving glass can be moved.

4. The roller blind apparatus for panoramic sunroofs as set forth in claim 3, wherein
the front blind overmold is provided with an insert part that protrudes so as to be inserted into a lower surface of the guide lever;
the guide lever is provided in the lower surface thereof with a holding part into which the insert part can be inserted, with a hook part being provided in a second end of the guide lever so that the hook part can be inserted into the winding guide; and
the winding guide is provided in a lower surface thereof with a hooking groove into which the hook part can be inserted.

5. The roller blind apparatus for panoramic sunroofs as set forth in claim 4, wherein the hook part includes:
an upper surface inclined downward in a direction toward the hinged end of the guide lever; and
a lower surface inclined downward in a state in which the lower surface forms an acute angle with the upper surface of the hook part.

6. The roller blind apparatus for panoramic sunroofs as set forth in claim 3, further comprising:
a control hook moving along with the front blind overmold to a stop position of the front roller blind, thereby aiding an opening motion of the front roller blind.

7. The roller blind apparatus for panoramic sunroofs as set forth in claim 3, further comprising:
a stopper mounted to the mechanism overmold and configured such that, when the guide lever is inserted into the winding guide, the stopper is rotated by a tensile force and supports a lower part of the guide lever, thereby preventing a downward movement of the guide lever.

8. The roller blind apparatus for panoramic sunroofs as set forth in claim 1, wherein the power transmission unit is provided on each of guide rails that are placed in opposite sides of the vehicle roof panel.
